(19) United States
(12) Patent Application Publication
(10) Pub. No.: US 2017/0348078 A1
(43) Pub. Date: Dec. 7, 2017

(54) TOOTHPICK FOR PERIODONTAL CARE

(71) Applicant: Dae Kyung LEE, Seongnam-si, Gyeonggi-do (KR)

(72) Inventor: Dae Kyung LEE, Seongnam-si, Gyeonggi-do (KR)

(21) Appl. No.: 15/540,869

(22) PCT Filed: Dec. 24, 2015
(86) PCT No.: PCT/KR2015/014288

§ 371 Date: Jun. 29, 2017

(30) Foreign Application Priority Data
Dec. 29, 2014 (KR) 10-2014-0191852

(51) Int. Cl. A61C 15/02; A61J 1/06; A61C 19/06

(52) U.S. Cl. CPC A61C 15/02; A61C 19/063; A61J 1/067

(57) ABSTRACT

Disclosed is a toothpick for periodontal care for applying a drug in an oral cavity. The toothpick for periodontal care according to the present invention includes: a drug container which accommodates a drug for periodontal care; and a toothpick part which is provided at one end portion of the drug container and has a nozzle hole that is formed in a longitudinal direction and communicates with an internal space of the drug container so as to apply the drug for periodontal care between a user's teeth.

### TECHNICAL FIELD

The present invention relates to a toothpick for periodontal care which is used to apply a drug within an oral cavity, and more particularly, to a toothpick for periodontal care which is used to easily apply a drug for treating periodontal diseases within an oral cavity.

### BACKGROUND ART

In general, a toothbrush is used to clean the teeth and remove food detritus between the teeth after a meal. In some instances, patients receive treatment at the hospital for periodontal care. Therefore, recently, users often have periodontal care by using a water spray type portable tooth cleaner for removing food detritus with water pressure by spraying water in an oral cavity. That is, the sprayed water collides with the food detritus, and thus the food detritus is removed from the teeth by water pressure.

However, the user cannot often visit the dentist, and the toothbrush or the tooth cleaner is used merely to remove the food detritus that is just externally exposed, and as a result, there is a problem in that it is impossible to effectively remove bacteria that cause periodontal diseases.

Therefore, the patient needs to apply a drug for treating periodontal diseases in his/her oral cavity by himself/herself.

In this regard, Korean Patent Application Laid-Open No. 2007-0089746 (entitled “Local and Residual Application System for Intra-Oral Medications”, published on Aug. 31, 2007) discloses a technology which is suitable to remove foreign substances between the teeth. The application system has a toothpick shape so as to allow a user to conveniently use the application system, and improve an effect of removing foreign substances. However, there is a problem in that the application system has a complicated structural shape, which requires an increased number of fabricating and forming processes and causes a large amount of production costs. In addition, the application system is not suitable to be mass-produced.

Therefore, the present applicant has developed the present invention by using a dual injection molding method in order to solve the aforementioned problems, provide a container that enables a patient to easily apply a drug for treating periodontal diseases in his/her oral cavity by himself/herself, and provide a technology for manufacturing the container with a simple structure with low costs.

### DISCLOSURE

### Technical Problem

An object of the present invention is to provide a toothpick for periodontal care which enables a user to easily apply a drug for periodontal care to all over an oral cavity and improves convenience for the user.

### Technical Solution

The aforementioned object is achieved by a toothpick for periodontal care according to the present invention, the toothpick including: a drug container which accommodates a drug for periodontal care; and a toothpick part which is provided at one end portion of the drug container and has a nozzle hole that is formed in a longitudinal direction and communicates with an internal space of the drug container so as to apply the drug for periodontal care between a user's teeth.

Particularly, the drug container may include: a container extrusion part which is deformed by being pushed by the user and extrudes the drug for periodontal care through the toothpick part; and a container support part which is connected to the container extrusion part, is made of a material harder than a material of the container extrusion part, and imparts rigidity to the drug container.

Particularly, the container extrusion part may be extended along the container support part from one end portion to the other end portion of the container support part.

Particularly, based on a cross section of the drug container, the container extrusion part may define one side of the drug container, and the container support part may define the other side of the drug container.

Particularly, the container support part may be shaped to be fully filled with a material and does not accommodate the drug for periodontal care.

Particularly, the container extrusion part may be made of a plastically deformable material.

Particularly, the toothpick part may be separably coupled to the drug container or formed integrally with the drug container, and the container extrusion part and the container support part may be integrally formed by a dual injection molding method.

Particularly, an end of the toothpick part may be rounded.

Particularly, the toothpick for periodontal care may further include a protective cap which is separably coupled to the drug container or the toothpick part.

Particularly, the toothpick part may be shaped to be bent at a predetermined angle in the longitudinal direction.

### Advantageous Effects

The present invention provides a dual material structure or a dual structure in which the drug container, which accommodates the drug for periodontal care, has a soft portion for extruding the drug, and a hard portion for imparting rigidity, and as a result, the drug for periodontal care may be easily applied to all over the oral cavity, and convenience for the user may be improved.

### DESCRIPTION OF DRAWINGS

FIG. 1 is a perspective view of a toothpick for periodontal care according to an exemplary embodiment of the present invention.

FIG. 2 is an enlarged view taken along line a-a′ in FIG. 1, in which a protective cap and a nozzle hole of a toothpick part are distinguishably illustrated.

FIG. 3 is a view illustrating a feature of the toothpick part in FIG. 1.

FIG. 4 is a view illustrating an image of the toothpick for periodontal care according to the present invention when a user pushes a container extrusion part.

FIG. 5 illustrates bottom plan views illustrating various shapes of the container extrusion part and a container support part of a drug container in FIG. 1.

FIG. 6 is a view illustrating a toothpick for periodontal care according to a second exemplary embodiment of the present invention.

FIG. 7 is a view schematically illustrating a state in which the user applies a drug between his/her teeth through the toothpick part by pushing the container extrusion part.

### BEST MODE

In order to sufficiently understand the object that will be achieved by the present invention, advantages in operation of the present invention, and implementation of the present invention, reference needs to be made to the accompanying drawings for illustrating an exemplary embodiment of the present invention and contents disclosed in the accompanying drawings.

Hereinafter, an exemplary embodiment of the present invention will be described in detail with reference to the accompanying drawings. However, in the description of the present invention, a description of a function or configuration already publicly known will be omitted in order to clearly define the subject matter of the present invention.

In several exemplary embodiments, constituent elements having the same configuration will be representatively described using the same reference numerals in a first exemplary embodiment, and only configurations different from the configurations in the first exemplary embodiment will be described in the other exemplary embodiments.

Hereinafter, a toothpick for periodontal care according to a first exemplary embodiment of the present invention will be described in detail with reference to the accompanying drawings.

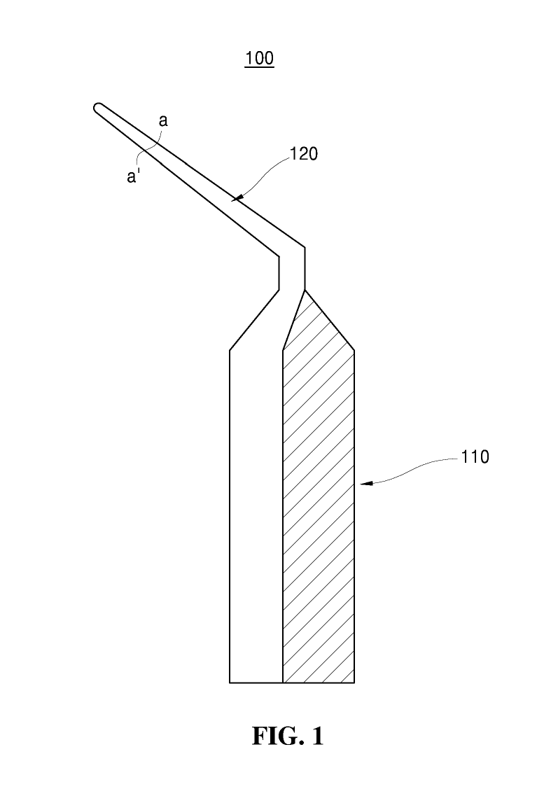

FIG. 1 is a perspective view of a toothpick 100 for periodontal care according to a first exemplary embodiment of the present invention. As illustrated in FIG. 1, the toothpick 100 for periodontal care may include a drug container 110 which accommodates a drug 115 for periodontal care, and a toothpick part 120 which is provided at one end portion of the drug container 110 and has a nozzle hole 121 that is formed in a longitudinal direction and communicates with an internal space of the drug container 110, and the toothpick part 120 is used to apply the drug 115 for periodontal care between a user's teeth.

That is, the toothpick 100 for periodontal care according to the present invention may include the drug container 110 and the toothpick part 120 in order to enable the user to manage the periodontal care by pushing the drug container 110 which accommodates the drug 115 for periodontal care, and thus applying the drug 115 for periodontal care between the user's teeth through the toothpick part 120.

The drug 115 for periodontal care, which is accommodated in the drug container 110 of the toothpick 100 for periodontal care according to the present invention, may contain only chlorhexidine, or may further contain Listerine, propylene glycol, hydroxypropylcellulose, purified water, and pharmacologically permissible additives. That is, any drug may be used as the drug 115 for periodontal care as long as the drug may be used to clean the oral cavity and may be harmless to human bodies. In addition, the type of drug 115 for periodontal care is not limited as long as the drug may be provided between the user's teeth to remove residual substances remaining between the user's teeth, or supplied between the user's teeth to eliminate bacteria that cause periodontal diseases.

The drug container 110 serves as a main body of the present invention, and the drug container 110 of the toothpick 100 for periodontal care according to the present invention may serve as a handle to be held by the user. In this case, the drug container 110 may be configured such that the user may stably hold the drug container 110, and the shape of the drug container 110 is not restricted. In addition, a groove may be provided at one side of the drug container 110 in order to allow the user to easily hold the drug container 110.

The toothpick part 120 allows the drug 115 for periodontal care, which is accommodated in the drug container 110, to be moved and applied between the user's teeth, and the toothpick part 120 may be separably coupled to the drug container 110, or formed integrally with the drug container 110. That is, the toothpick part 120 may be replaceable, and may be provided to be separated from the drug container 110.

The reason is to allow the toothpick part 120 contaminated by being used to be easily replaced, and thus to prevent infection in periodontal diseases when many people share the toothpick 100 for periodontal care according to the present invention.

Meanwhile, the toothpick part 120 may be integrally or separably coupled to the drug container 110. In a case in which the toothpick part 120 is separably coupled to the drug container 110, a groove may be formed in a surface or a space through which the drug container 110 and the toothpick part 120 are in contact with each other, such that the toothpick part 120 is coupled into the groove. The toothpick part 120 may be coupled to the drug container 110 through a threaded connection so that the drug container 110 may be assuredly closed. Therefore, a coupling relationship between the toothpick part 120 and the drug container 110 is not limited.

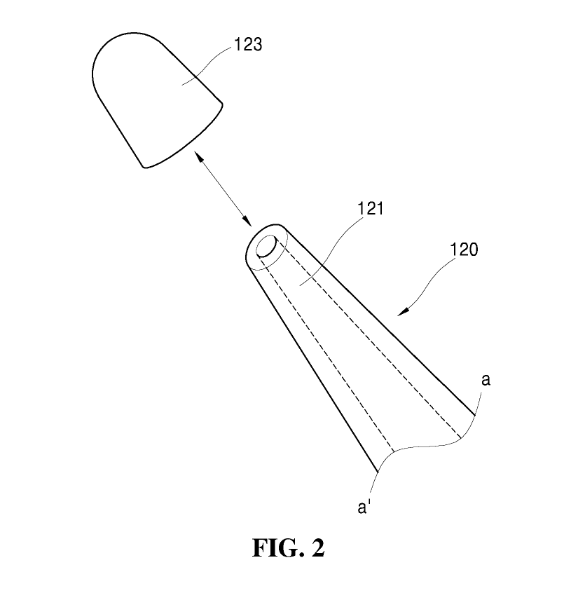

FIG. 2 is an enlarged view taken along line a-a′ in FIG. 1, in which a protective cap 123 and the nozzle hole 121 of the toothpick part 120 are distinguishably illustrated. As illustrated in FIG. 2, an end of the toothpick part 120 may be rounded. A diameter of the toothpick part 120 may be decreased toward the end of the toothpick part 120 in order to apply the drug between the user's teeth.

That is, the toothpick part 120 has a shape of a toothpick, such that the drug 115 for periodontal care may be locally applied between the user's teeth. Since the end of the toothpick part 120 is rounded, it is possible to prevent the user from feeling threatened and to improve usability.

In addition, any one material selected from silicone, brushes, and plastic or synthetic resin flexible materials may be used as a material of the toothpick part 120 in accordance with a state of the user's teeth. Therefore, the gums or the teeth are not damaged even though the end of the toothpick part 120 is pushed between the teeth with high force.

The toothpick 100 for periodontal care may further include the protective cap 123 which is separably coupled to the drug container 110 or the toothpick part 120. The protective cap 123 may be provided to cover the end of the toothpick part 120 for the purpose of carrying and storing the toothpick 100 for periodontal care. In addition, the protective cap 123 may be made of silicone, rubber, or plastic, but the material of the protective cap 123 is not limited.

FIG. 2 illustrates an example in which the protective cap 123 is coupled to the end of the toothpick part 120, but the protective cap 123 may be extended to a portion where the drug container 110 and an upper end of the toothpick part 120 are in contact with each other. Alternatively, the protective cap 123 may surround the entire drug container 110.

Meanwhile, referring to FIGS. 1 and 2, the nozzle hole 121 is provided in the toothpick part 120 and formed in a longitudinal direction so as to communicate with an internal space of the drug container 110.

That is, the nozzle hole 121 may be a flow path through which the drug 115 for periodontal care flows so as to be applied between the user's teeth. In this case, the nozzle hole 121 may be extended so that the drug 115 for periodontal care accommodated in the drug container 110 flows to the end of the toothpick part 120.

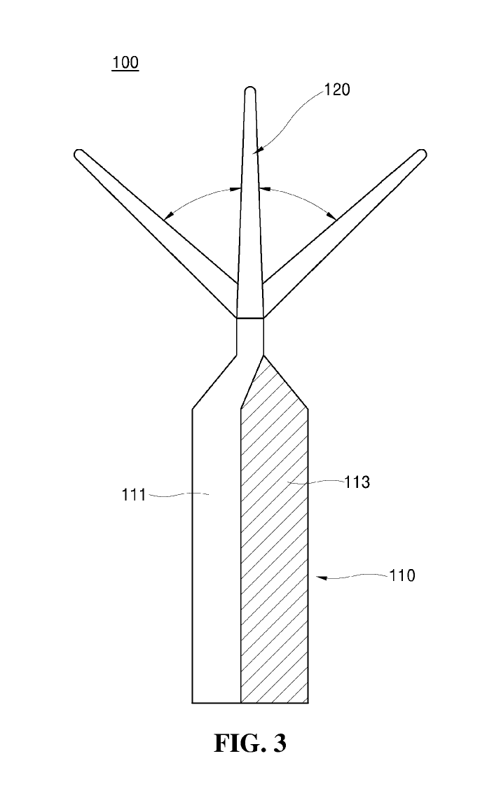

FIG. 3 is a view illustrating a feature of the toothpick part 120 in FIG. 1. As illustrated in FIG. 3, the toothpick part 120 may be shaped to be bent at a predetermined angle in the longitudinal direction. In this case, in accordance with a position of a diseased part (a position between the teeth), the user may manually bend the toothpick part 120 in any direction, or may straighten the toothpick part 120 in a straight line shape.

Therefore, since the toothpick part 120 is bent at a predetermined angle, the drug 115 for periodontal care may easily access any region in the user's oral cavity.

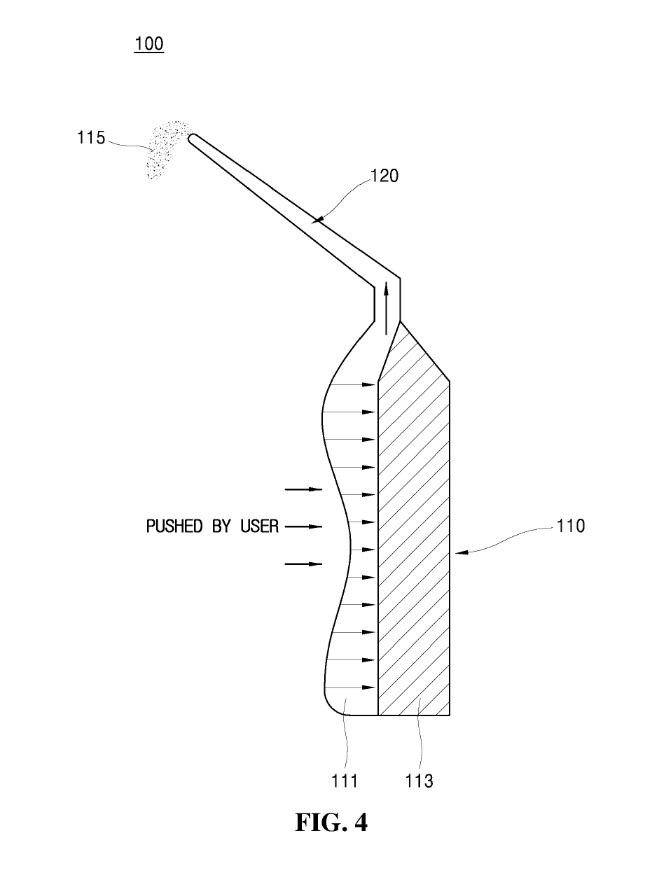

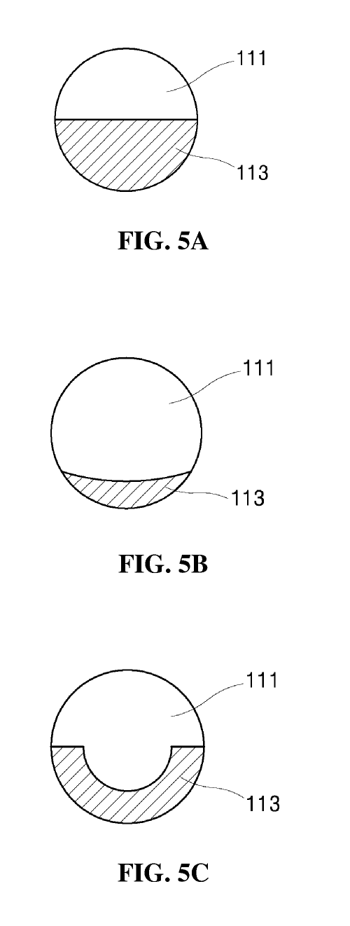

FIG. 4 is a view illustrating an image of the toothpick 100 for periodontal care according to the present invention when the user pushes a container extrusion part 111, and FIG. 5 is a bottom plan view illustrating various shapes of the container extrusion part 111 and a container support part 113 of the drug container 110 in FIG. 1.

As illustrated in FIG. 4, the drug container 110 may include the container extrusion part 111 which is deformed by being pushed by the user and extrudes the drug 115 for periodontal care through the toothpick part 120, and the container support part 113 which is connected to the container extrusion part 111, is made of a material harder than a material of the container extrusion part 111, and imparts rigidity to the drug container 110.

The drug container 110 is a key constituent element of the toothpick 100 for periodontal care according to the present invention, the container extrusion part 111 and the container support part 113 of the drug container 110 may be integrally formed by a dual injection molding method by using different materials.

That is, the container support part 113 is made of a material harder than a material of the container extrusion part 111 so as to support the drug container 110 when the user pushes the container extrusion part 111. As a result, when the user pushes the container extrusion part 111 made of a material softer than a material of the container support part 113, the drug 115 for periodontal care may be easily applied to the teeth, and the user may have improved gripping feeling.

Therefore, since the container support part 113 imparts rigidity to the drug container 110, the drug 115 for periodontal care in the container extrusion part 111 may easily come out (since one side is supported, the other side is easily pushed).

Based on a cross section of the drug container 110, the container extrusion part 111 defines one side of the drug container 110, and the container support part 113 defines the other side of the drug container 110. The container extrusion part 111, which is one side of the drug container 110, receives pressure from the user, and the container support part 113, which is the other side of the drug container 110, may serve to support the pressure.

Therefore, when the user pushes the drug container 110, the container extrusion part 111 is compressed, and the container support part 113 supports the force that compresses the container extrusion part 111, such that the drug 115 for periodontal care may easily flow to the toothpick part 120.

The container extrusion part 111 stores the drug 115 for periodontal care, and an outer surface of the container extrusion part 111 may be deformed by being pushed by the user when the drug 115 for periodontal care flows to the toothpick part 120 and then is extruded to the outside. That is, a volume of the container extrusion part 111 may be decreased by the amount of extruded drug.

In contrast, the container support part 113 may be shaped to be fully filled with a material, and the container support part 113 may not accommodate the drug 115 for periodontal care. That is, the container support part 113 imparts rigidity to the drug container 110 and serves to support the container extrusion part 111 when the container extrusion part 111 is pushed, and as a result, the container support part 113 may not accommodate the drug 115 for periodontal care. In other words, a volume of the container support part 113 is not changed.

The container extrusion part 111 or the toothpick part 120 may be made of a transparent material so that a flow of the drug 115 for periodontal care is visible.

The container extrusion part 111 may be made of a plastically deformable material. That is, the container extrusion part 111 may be made of a material having no elastic restoring force by which the container extrusion part 111 returns back to the original position by being pushed by the user. This enables the user to ascertain a usage amount (the amount of extruded drug) in accordance with the user's effort to push the container extrusion part 111, and has an effect of adjusting the usage amount (the amount of extruded drug).

In addition, the container extrusion part 111 may be made of a silicone material or may be made of a flexible plastic material, rubber, aluminum, and the like, but the material of the container extrusion part 111 is not limited.

FIG. 5 is a bottom plan view illustrating various shapes of the container extrusion part 111 and the container support part 113 of the drug container 110 in FIG. 1. As illustrated in FIGS. 5A, 5B, and 5C, the container extrusion part 111 may be extended along a circumference of the container support part 113 from one end portion to the other end portion of the container support part 113.

FIGS. 5A, 5B, and 5C illustrate various shapes of the drug container 110 when viewed from a bottom side while changing regions of the container extrusion part 111 and the container support part 113. In this case, the container extrusion part 111 may be shaped such that the container extrusion part 111 is well pushed by the user and the drug 115 for periodontal care may easily come out. The container support part 113 may be shaped such that the container support part 113 may impart rigidity to the drug container 110 and may support the container extrusion part 111 so that the container extrusion part 111 may be well pushed when the container extrusion part 111 is pushed by the user.

Therefore, the shapes of the container extrusion part 111 and the container support part 113 are not limited to the exemplary embodiment.

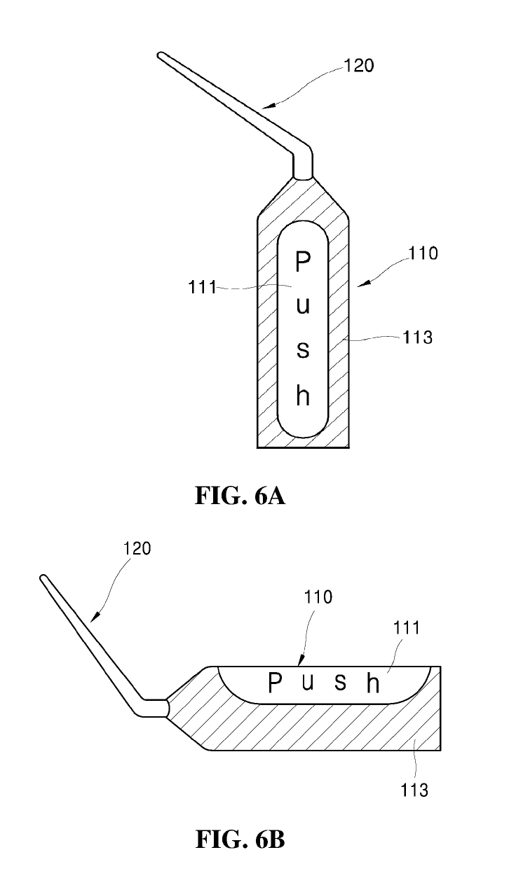

FIG. 6 is a view illustrating a toothpick 100 for periodontal care according to a second exemplary embodiment of the present invention. As illustrated in FIGS. 6A and 6B, the toothpick 100 for periodontal care according to the second exemplary embodiment of the present invention may include the drug container 110 and the toothpick part 120 in order to enable the user to clean his/her teeth and manage the periodontal care by pushing the drug container 110 which accommodates the drug 115 for periodontal care, and thus applying the drug 115 for periodontal care between the user's teeth through the toothpick part 120.

That is, the toothpick 100 for periodontal care may include the drug container 110 which accommodates the drug 115 for periodontal care, and a toothpick part 120 which is provided at one end portion of the drug container 110 and has the nozzle hole 121 that is formed in a longitudinal direction and communicates with the internal space of the drug container 110, and the toothpick part 120 is used to apply the drug 115 for periodontal care between the user's teeth.

In the toothpick 100 for periodontal care according to the second exemplary embodiment of the present invention, the drug container 110, which is held by the user, serves as a main body of the present invention, and the toothpick part 120 serves to allow the drug 115 for periodontal care to be appropriately applied to the user's diseased part, and as a result, the toothpick 100 may perform the same function as the toothpick in the first exemplary embodiment.

However, the shapes of the container extrusion part 111 and the container support part 113, which constitute the drug container 110, may be changed. Therefore, a support surface of the container support part 113 may be widened when changing the shape of the container support part 113, thereby imparting stability to the user. In addition, for convenience for the user, the shape of the container extrusion part 111 may be changed such that the container extrusion part 111 may be easily pushed by finger.

Therefore, the shape of the present invention is not limited to those in the first and second exemplary embodiments, and may be embodied in various forms.

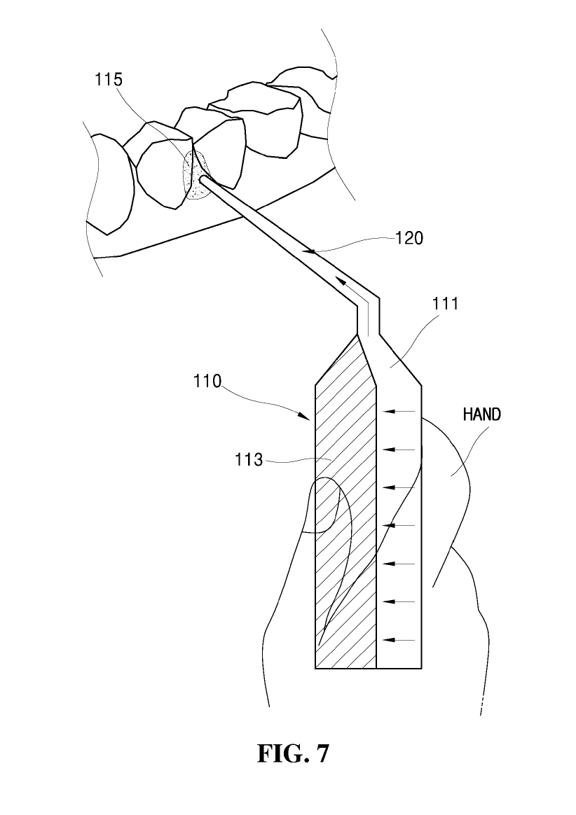

FIG. 7 is a view schematically illustrating a state in which the user applies the drug 115 for periodontal care between his/her teeth through the toothpick part 120 by pushing the container extrusion part 111.

From now, operations of the first and second exemplary embodiments of the toothpick 100 for periodontal care according to the present invention will be described with reference to FIG. 7.

The user separates the protective cap 123 provided on the toothpick 100 for periodontal care according to the present invention.

The user places the end of the toothpick part 120 of the toothpick 100 for periodontal care between his/her teeth. In this case, the user adjusts an angle of the toothpick part 120 in accordance with a position of his/her teeth.

The user pushes the container extrusion part 111 of the drug container 110 by finger. The container support part 113 supports the force of the user, such that the drug 115 for periodontal care accommodated in the container extrusion part 111 is easily extruded to the outside of the toothpick part 120 through the nozzle hole 121. In this case, the drug 115 for periodontal care flows in a direction of the arrow. In addition, the amount of the drug 115 for periodontal care may be adjusted by adjusting pressure of the user.

As a result, the drug 115 for periodontal care, which is extruded to the outside through the toothpick part 120, is applied between the user's teeth, thereby removing residual substances remaining between the user's teeth or eliminating bacteria that cause periodontal diseases.

For reference, the toothpick 100 for periodontal care according to the present invention may be used not only to manage the periodontal care, but also to clean the teeth, remove plaque, and enhance the gums. The existing toothpick is made of a hard material, but the end of the toothpick part 120 of the present invention is rounded, and the toothpick part 120 is made of a material that does not damage the gums. In addition, the toothpick 100 may be used for the inherent purpose of removing contaminants and plaque between the teeth.

The toothpick 100 for periodontal care according to the present invention may be manufactured by a simple method like a disposable toothpick. That is, as described above, the toothpick 100 for periodontal care according to the present invention does not have structural complexity, and as a result, the toothpick 100 may be manufactured by general dual injection molding, such that manufacturing costs of the toothpick 100 are reduced and usability of the toothpick 100 is increased.

In addition, the container extrusion part 111 and the container support part 113 are made of different materials, and as a result, the drug 115 for periodontal care may be easily extruded, and the user may intuitively ascertain how to use the toothpick 100 when the user sees the drug container 110.

It is obvious to those skilled in the art that the present invention is not limited to the aforementioned exemplary embodiments, and may be variously changed and modified without departing from the spirit and the scope of the present invention. Therefore, the changed or modified exemplary embodiments are included in the claims of the present invention.

### INDUSTRIAL APPLICABILITY

The present invention may be used in industries related to an instrument for applying a drug for periodontal care in an oral cavity.

1. A toothpick for periodontal care, comprising:
a drug container which accommodates a drug for periodontal care; and
a toothpick part which is provided at one end portion of the drug container and has a nozzle hole that is formed in a longitudinal direction and communicates with an internal space of the drug container so as to apply the drug for periodontal care between a user's teeth.

2. The toothpick of claim 1, wherein the drug container includes:
a container extrusion part which is deformed by being pushed by the user and extrudes the drug for periodontal care through the toothpick part; and
a container support part which is connected to the container extrusion part, is made of a material harder than a material of the container extrusion part, and imparts rigidity to the drug container.

3. The toothpick of claim 2, wherein the container extrusion part is extended along the container support part from one end portion to the other end portion of the container support part.

4. The toothpick of claim 2, wherein based on a cross section of the drug container, the container extrusion part defines one side of the drug container, and the container support part defines the other side of the drug container.

5. The toothpick of claim 4, wherein the container support part is shaped to be fully filled with a material and does not accommodate the drug for periodontal care.

6. The toothpick of claim 2, wherein the container extrusion part is made of a plastically deformable material.

7. The toothpick of claim 2, wherein the toothpick part is separably coupled to the drug container or formed integrally with the drug container, and
the container extrusion part and the container support part are integrally formed by a dual injection molding method.

8. The toothpick of claim 1, wherein an end of the toothpick part is rounded.

9. The toothpick of claim 1, further comprising:
a protective cap which is separably coupled to the drug container or the toothpick part.

10. The toothpick of claim 1, wherein the toothpick part is shaped to be bent at a predetermined angle in the longitudinal direction.
